(19) United States
(12) Patent Application Publication
(10) Pub. No.: US 2019/0101445 A1
(43) Pub. Date: Apr. 4, 2019

(54) Method and Apparatus for Hyperspectral Imaging

(71) Applicant: Michael John Darwin, Portland, OR (US)

(72) Inventor: Michael John Darwin, Portland, OR (US)

(21) Appl. No.: 16/145,957

(22) Filed: Sep. 28, 2018

Related U.S. Application Data
(60) Provisional application No. 62/565,162, filed on Sep. 29, 2017.

(51) Int. Cl. G01J 3/28; G01J 3/26; G01J 3/433; G01N 21/3504; G01N 21/31

(52) U.S. Cl. CPC G01J 3/2823; G01J 3/26; G01J 2003/2826; G01N 21/3504; G01N 21/314; G01J 3/4338

(57) ABSTRACT

A method and apparatus for the generation of hyperspectral images for an object consisting of a broad band light projection systems, a means of modulating the wavelength of the light, one or more sensors for observing the reflected light, one or more electronic means of synchronizing and extracting data from the sensor, one or more sensors for registering position, one or more calibration methods for rationalizing the data, and one or more algorithms for analyzing the data to produce the hyperspectral image.

### CROSS REFERENCE TO RELATED APPLICATION

This application claims the benefit of U.S. Provisional Application No. 62/565,162 filed on Sep. 29, 2017, entitled “Method and Apparatus for Hyperspectral Imaging.”

### BACKGROUND OF INVENTION

### Field of Invention

The present invention relates to the non-contact methods and apparatus used for measuring hyperspectral images, or equivalently the spectral content of a sample at numerous locations such that an image can be constructed at one or more wavelengths of interest. A few industries utilize hyperspectral imaging to insure quality control, sound manufacturing practices, and in some cases direct integration into manufacturing processes. (4, 5, 6) A few of these industries are discussed below, however these industries share a concerns of costs and throughput when apply this technology.

In the case of the food industry, optical sorters have become common place. These optical sorters typically use a camera, a general-purpose white light source, and some specialized software to identify defects or foreign material. In some instances, the optical sorter may use a laser scanning system instead of a white light source and replace a camera with a light sensitive sensor. Once identified, the defect, foreign body, or contamination is removed either manually or automatically from the processing line. Unfortunately, not all defects or foreign materials can be easily identified using white light or single wavelength images. However, identifying the spectral signature of what is “good” from what is considered “bad” can be used to increase the capture rate of certain defects. (4)

In the case of semiconductor industry, the use of spectral signatures has been used in sophisticated wafer inspection tools to enable the identification of defects (such as Rudolph Technologies WaferView Systems. Though limited to only RGB channels, the information extracted from these color channels has enabled advanced learning algorithms to not only identify defects, but to sort them by characteristics inclusive of their color content. This approach could benefit from an inspection scheme in which the all the spectral content across a wavelength range could be utilized in identifying and sorting defects.

The agricultural industry is beginning to use such an approach to monitor the health of crops. (7) Specifically, Australia is beginning to use imaging spectrometers as an early warning system against ailments that may impact their grape production. Additional work is underway to use hyperspectral data to identify the chemical composition of plants, thereby enabling scientist and farmers with information that can be used to increase crop yields.

### Description of Prior Art

Much prior art exists for systems that can perform hyperspectral imaging. Many of these systems use a form of scanning to extract information; the scanning can either be in the spatial dimension or in the wavelength dimension. Most hyperspectral imaging (HSI) devices that scan spectrally rely on a 2D imaging devices and a method to create monochromatic light using a band pass filter.(9, 10, 11, 12) A few of these approaches will utilize a filter wheel concept, in which inserts a physical bandpass filter into the either the light source or in the imaging path to produce the monochromatic data; these approaches are slow and are often limited by the mechanical devices used to change the filter. The filter wheel approaches are often limited in the number of wavelengths that can be practically used, but can offer high wavelength integrity. If an electronic means of applying the band pass filter is used, such as in the case of acousto-optic-tunable filters (AOTF), which replaces the mechanical filter on either the illumination or imaging legs of the apparatus, then wavelength resolution may be enhanced. Unfortunately, the speed of the measurement may still be considered slow and thus limiting many practical industrial applications.

### SUMMARY OF INVENTION

The present invention provides a method and apparatus for generating hyperspectral images of a given sample at various densities of spatial sampling. The sample can be scanned locally or over large areas enabling a fast, local or less dense, sampling or more detail sampling, of the spatial content over the field of view. The scanning can be accomplished via a set of galvanometric scanners, a rotating polygon scanner with galvanometric scanner, rotating polygon with galvanometric scanner and scanning stage, or a large area imaging sensor. Various sensors can be used to enable the optical layouts described above including but not limited to line scan cameras, areal cameras, photo-diodes, etc. The light source is sufficiently broadband to cover the spectral range of interest, and bright enough to enable sufficient transmission to the sample surface. A tunable filter, such as an AOTF, will be used to modulate specific wavelength over the bandwidth of the light source and/or sensor. Unlike other approaches, the spectral content is collected at each data point by “CHIRPING” the AOTF in the appropriate bandwidth range and reading the detector sufficiently fast to satisfy Nyquist's requirements for the highest band measured. As such, only one area scan is required to collect all spectral information. In the case of areal based or line scan cameras, this may require building circuitry onto the imaging sensor itself to enable demodulation of the “CHIRPED” signal to allow for the highest throughput possible.

The “CHIRP,” or modulation signal, will provide amplitude and frequency modulation for each wavelength of interest across a given spectrum. The “CHIRP” can be tunable and/or selective to one or more specific wavelengths by adjusting the transmission of the filter at the corresponding band pass. The sensor data will be collected and demodulated into its individual spectral components as defined by the “CHIRP.”

The modulated nature of the apparatus will naturally allow for background noise suppression; low level signals can be differentiated from back ground noise by using a number of different techniques, including time and frequency based filtering, lock-in detections schemes, or other. The image scanning must be synchronized to the light “CHIRP” to insure purity of spectral content within a defined bandwidth.

### BRIEF DESCRIPTION OF THE DRAWINGS

FIG. 1 A possible system layout consisting of a light source, imaging and collimation optics, full and partially reflective mirrors, a tunable wavelength filter, a sensor capable of measuring the structured light across multiple wavelengths, multiple electronic drivers capable of synchronizing the wavelength filter with the sensor, and a computer system that will be used to synchronize, gather and analyze data. In this system layout, the wavelength filter is on the illumination leg of the apparatus.

FIG. 2 A possible system layout consisting of a light source, imaging and collimation optics, full and partially reflective mirrors, a tunable wavelength filter, a sensor capable of measuring the structured light across multiple wavelengths, multiple electronic drivers capable of synchronizing the wavelength filter with the sensor, and a computer system that will be used to synchronize, gather and analyze data. In this system layout, the wavelength filter is on the imaging leg of the apparatus.

FIG. 3 A modulation/demodulation scheme in which the modulation occurs via hardware drivers and the demodulation occurs through an optimized software program using off the shelf hardware components.

FIG. 4 A modulation/demodulation scheme in which the modulation occurs via hardware drivers and the demodulation occurs through an optimized set of hardware/electronics components.

### DETAILED DESCRIPTION OF INVENTION

Reference is made herein to the attached drawings. Like reference numerals are used throughout the drawings to explain elements of the hyperspectral measurements instrument. For the purpose of presenting a brief and clear description of the invention, the preferred embodiments will be discussed as used for the measurement of reflectivity of a sample. The figures are intended for representative purposes only and should not be considered limiting in any aspect.

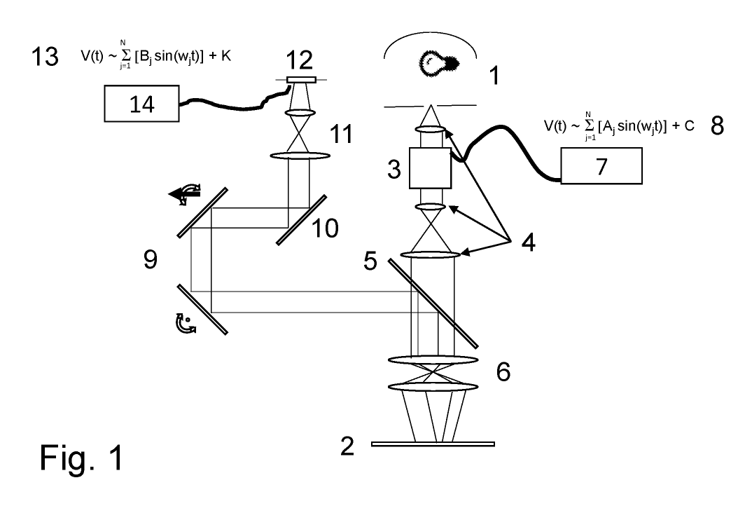

Referring to FIG. 1, a light source capable of broadband illumination 1 is projected onto the sample area 2. The light passes through a tunable wavelength filter 3, set of collimated or near collimating optics 4, a beam splitting/half silvered mirror 5, and imaging optics 6. The wavelength of the tunable filter 3 is modulated by driver 7; specifically, the filter is changed systematically through a series of wavelengths in a repeated fashion, such that the repetition rate becomes its own frequency base. The lower frequency repetition rate, or base carrier, when combined with the higher frequency wavelength sweep, represents a CHIRP signal. As such, all wavelengths are represented by a common frequency with known phase relationship based upon the programmed modulation; a simple representation of the Fourier components of the illumination is shown by the relationship 8. The reflected light from sample 2 is gathered by the same imaging optics 6, and is reflected off the beam splitting/half silvered mirror 5 into a galvanometric mirror pair 9. For this representation of the invention, the galvanometric mirror pair 9 enable either a full or partial imaging of the sample area 2. The imaging light is transfer through one or more mirrors 10, one or more conditioning optics 11, and into one or more sensors 12. For this embodiment, the sensor 12 can either be sampled fast enough, such that the highest represented frequency in the illumination is captured or the sensor 12 can be programmed to sub sample at the (or multiple thereof) repeat frequency with known phase offsets. The subsequent data stream will be represented by Fourier components 13, similar to the Fourier components of the illumination leg 8. The sensor data stream can either be analyzed by a computer with custom software or custom electronics 14. Additionally, the positions and/or movements of the galvanometric mirrors 9 are synchronized with the data stream in 14, thus enabling the reconstruction of the areal reflectance from the sample 2. The end result is a data cube representing X and Y locations defined by the galvanometric mirrors 9 and reflectance value representing the wavelength dependence of the sample; the reflectance data will need to be normalized with respect to a known sample in order to remove the wavelength dependence of the light source.

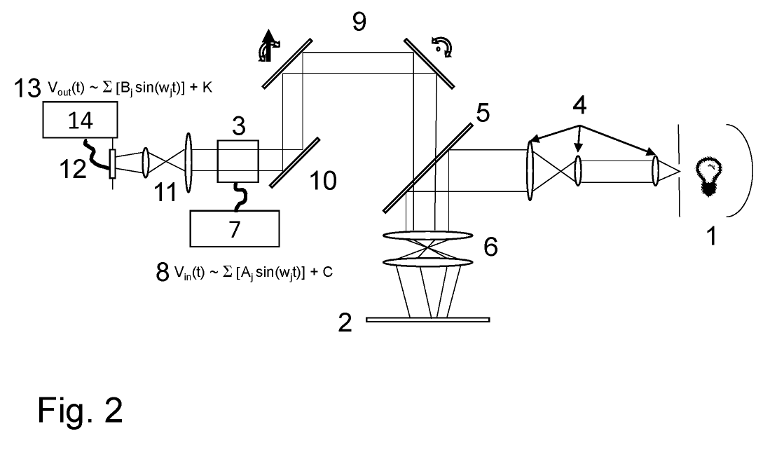

An alternative embodiment of the apparatus is presented in FIG. 2; for this incarnation, the wavelength tunable filter 7 is inserted into the imaging leg of the apparatus instead of the illumination leg as described in FIG. 1. Operation of the wavelength modulation, data sampling, and analysis schemes may occur in an identical fashion as described above. The apparatus described in FIG. 1 has inherent advantages in terms of stray light filtering that do not exist in the apparatus described in FIG. 2; however, natural extensions of the apparatus described in FIG. 2 enables more flexibility in the choice of light source 1 and associated optics 4, 5, 6. Specifically, items 1, 4, and 5 can be removed from the apparatus described in FIG. 2, replaced with ambient diffuse lighting, and the apparatus will perform in a similar manner. Additionally, even though embodiments show in FIG. 1 and FIG. 2 are brightfield configurations, darkfield configurations of the system can obviously be made.

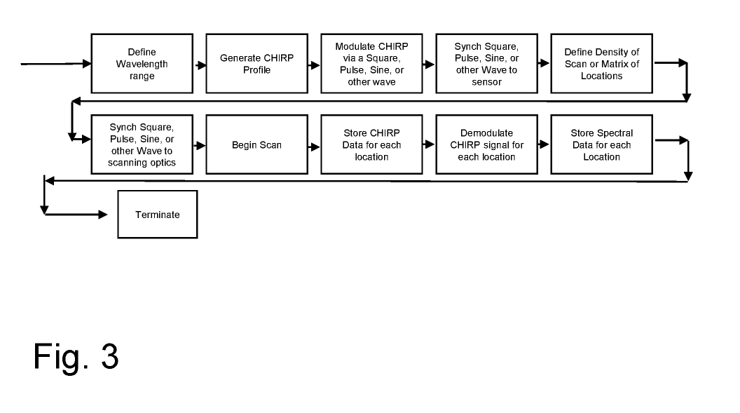

Referring to FIG. 3, one implementation of a method for modulation and demodulation is presented. Within this scheme, the modulation occurs via hardware drivers and the demodulation occurs through an optimized software program using off the shelf hardware components. This approach stores all sampled data into computer memory, which is later recalled for demodulation and subsequent analysis. The demodulation happening via software can occur by either a Fourier analysis of the represented frequencies or by mixing a software representation of the modulated signal with the measured data stream. A strict phase relationship between the CHIRP, modulation, and sensor sampling frequency must be maintained.

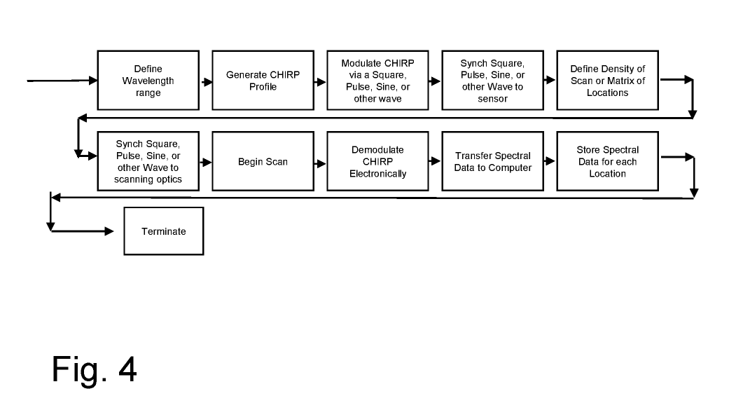

Referring to FIG. 4, an alternative method of modulation and demodulation is presented. Specifically, within this scheme, the modulation occurs via hardware drivers and the demodulation occurs through an optimized set of hardware and/or electronics components. In this approach, the signal used to drive the CHIRP production is fed directly in to the optimized electronics, enabling the extraction of reflected light as a function of the wavelength sweep.

### REFERENCES

1) US Patent Application 209/0236525 A1, Sep. 24, 2009 [Assignee: DRS Sensors & Targeting Systems, Inc].
2) U.S. Pat. No. 7,067,784 B1, Jun. 27, 2006 [Assignee: QinetiQ Limited].
3) DE102014002514B4, Filing Date: 2014 Feb. 21 [Assignee: Stuttgart University].
4) Higgins, Kevin. “Five New Technologies for Inspection”. Food Processing. 6 Sep. 2013.
5) Holma, H., “Thermische Hyperspektralbildgebung im langwelligen Infrarot”, Archived Jul. 26, 2011, at the Wayback Machine, Photonik May 2011.
6) Farley, V., Chamberland, M., Lagueux, P., et al., “Chemical agent detection and identification with a hyperspectral imaging infrared sensor,” Proceedings of SPIE Vol. 6661, 66610L (2007).
7) Lacar, F. M., et al., “Use of hyperspectral imagery for mapping grape varieties in the Barossa Valley, South Australia,” Geoscience and remote sensing symposium (IGARSS'01)—IEEE 2001 International, vol. 6 2875-2877p. doi:10.1109/IGARSS.2001.978191.
8) Ferwerda, J. G. (2005), “Charting the quality of forage: measuring and mapping the variation of chemical components in foliage with hyperspectral remote sensing,” Wageningen University, ITC Dissertation 126, 166p. ISBN 90-8504-209-7.
9) http://www.microscopyu.com/articles/confocal/spectralimaging.html
10) McNamara, G., Larson, J., et al., “Spectral Imaging and Linear Unmixing,” Nikon Instruments Inc., (http://www.microscopyu.com/articles/confocal/spectralimaging.html).
11) Coltof, G., “Hyperspectral Techniques Explained,” Bodkin Design and Engineering, (http://www.bodkindesign.com/wp-content/uploads/2012/09/Hyperspectral-1011.pdf).
12) Lu, G., Fei, B., “Medical hyperspectral imaging: review,” Journal of Biomedical Optics, 19(1), 010901 (2014).
13) Revolvy, “Hyperspectral Imaging,” (https://www.revolvy.com/main/index.php?s=Hyperspectral%20imaging).

I claim:

1) A method for hyperspectral imaging of an object or objects using a “CHIRP” modulation, the method comprising a light source of sufficient bandwidth and brightness, a tunable optical filter, such as an acousto-optic-transmission filter, with driver capable of “CHIRPING,” brightfield or darkfield illumination optics, lens of sufficient resolution to measure the samples, imaging optics, one or more sensor(s) of sufficient sensitivity and readout rate to enable sampling of the “CHIRP” signal, hardware and software to enable the creation of the “CHIRP” source and demodulation of the “CHIRP” signal, calibration method for normalizing the spectroscopic response, and hardware and software required for synchronizing data sampling with location of sample.

2) A method for hyperspectral imaging of an object or objects using a “CHIRP” modulation, the method comprising a light source of sufficient bandwidth and brightness, a tunable optical filter, such as an acousto-optic-transmission filter, with driver capable of “CHIRPING,” brightfield or darkfield illumination optics, lens of sufficient resolution to measure the sample, galvanometric scanner(s) with mirrors and programmable driver capable of scanning entire field of view, imaging optics, one or more sensor(s) of sufficient sensitivity and readout rate to enable sampling of the “CHIRP” signal, hardware and software to enable the creation of the “CHIRP” source and demodulation of the “CHIRP” signal, calibration method for normalizing the spectroscopic response, and hardware and software required for synchronizing data sampling with location of sample.

3) A method for hyperspectral imaging of an object or objects using a “CHIRP” modulation, the method comprising a light source of sufficient bandwidth and brightness, a tunable optical filter, such as an acousto-optic-transmission filter, with driver capable of “CHIRPING,” brightfield or darkfield illumination optics, lens of sufficient resolution to measure the sample, combination of rotating polygon scanner(s) with galvanometric mirror(s) and programmable driver capable of scanning entire field of view, imaging optics, one or more sensor(s) of sufficient sensitivity and readout rate to enable sampling of the “CHIRP” signal, hardware and software to enable the creation of the “CHIRP” source and demodulation of the “CHIRP” signal, calibration method for normalizing the spectroscopic response, and hardware and software required for synchronizing data sampling with location of sample.

4) A method for hyperspectral imaging of an object or objects using a “CHIRP” modulation, the method comprising a light source of sufficient bandwidth and brightness, a tunable optical filter, such as an acousto-optic-transmission filter, with driver capable of “CHIRPING,” brightfield or darkfield illumination optics, lens of sufficient resolution to measure the sample, combination of rotating polygon scanner(s) with galvanometric mirror(s) and scanning stage(s) and programmable driver capable of scanning entire field of view, imaging optics, one or more sensor(s) of sufficient sensitivity and readout rate to enable sampling of the “CHIRP” signal, hardware and software to enable the creation of the “CHIRP” source and demodulation of the “CHIRP” signal, calibration method for normalizing the spectroscopic response, and hardware and software required for synchronizing data sampling with location of sample.

5) A method for hyperspectral imaging of an object or objects using a “CHIRP” modulation, the method comprising a light source of sufficient bandwidth and brightness, a tunable optical filter, such as an acousto-optic-transmission filter, with driver capable of “CHIRPING,” brightfield or darkfield illumination optics, lens of sufficient resolution to measure the sample, combination of rotating polygon scanner(s) with galvanometric mirror(s) and scanning stage(s) and programmable driver capable of scanning entire field of view, imaging optics, one or more sensor(s) of sufficient sensitivity and readout rate to enable sampling of the “CHIRP” signal, hardware and software to enable the creation of the “CHIRP” source and demodulation of the “CHIRP” signal, calibration method for normalizing the spectroscopic response, hardware and software required for synchronizing data sampling with location of sample, and programmable sampling methodology to enable variable density sampling, area reconstruction of spectrally sampled areas, and optimized sampling speed.
